(19) United States
(12) Patent Application Publication
(10) Pub. No.: US 2007/0003772 A1
(43) Pub. Date: Jan. 4, 2007

(54) Method for metallizing a component comprising parts of different non-metallic materials

(76) Inventor: Roland Anthony Tacken, Eindhoven (NL)

Correspondence Address: MORRISON & FOERSTER LLP, 12531 HIGH BLUFF DRIVE, SUITE 100, SAN DIEGO, CA, 92130-2040, US

(21) Appl. No.: 10/575,732

(22) PCT Filed: Oct. 18, 2004
(86) PCT No.: PCT/NL04/00734

§ 371 Date: Apr. 13, 2006

(30) Foreign Application Priority Data
Oct. 17, 2003 (EP) 03078289.0

(51) Int. Cl. B05D 3/10; B05D 3/04; B32B 15/04

(52) U.S. Cl. 428/457; 427/331; 427/301; 427/304

(57) ABSTRACT

Method for metallizing a component, comprising a first part (1), made of a first material (e.g. polymer), and a second part (2), made of a second material (e.g. polymer). A metallizing seed layer (6), e.g. catalytic to the subsequent chemical metallization process, is applied at the surface of the component, after which the surface of the component, including the metallizing seed layer, is exposed to a solvent (7) in which the surface of the first part (1) is, and the surface of the second part (2) is not soluble. In a following step the surface of the component is exposed to a metallizing environment (9) that, however, will only be metallized on the surface of the second component part.

### FIELD OF THE INVENTION

The present invention relates to a method for metallizing a component that comprises a first part, constituted by a first non-metallic material, and a second part, constituted by a second non-metallic material.

### BACKGROUND OF THE INVENTION

Known methods for metallizing non-metallic components (consisting either one or more component parts) may comprise the following steps:
etching the component's surface to get a roughened and hydrophilic surface for good bonding properties;
surface sensitization, e.g. by adsorption of Sn ions to the surface;
surface activation, e.g. by reduction of Pd ions to metallic Pd by means of said Sn ions, resulting in a metallizing base layer or seed layer (hereinafter called “seed layer”) that is catalytic to the subsequent chemical metallization process;
metallizing and formation of a metal coating on the Pd seed layer by means of catalytic reduction of metal ions (e.g. Cu or Ni) from a solution that comprises both the relevant coating metal ions and a reduction chemical.

Components may comprise two or more component parts made from different materials. Such multi-material components may be fit for selective or partial metallizing. Several different methods for selective metallization are known, like selective surface conditioning (a), the use of pre-catalyzed polymers (b), laser activation (c) or lithographic techniques etc. (d).
(a) Selective surface conditioning: parts consisting of different materials are given a surface treatment using a solution for which the one part material does and the material of the other part does not show a strong adsorption behaviour (e.g. by using a specific combination of etching and sensitization as mentioned above). However, this method, using a “discriminating adsorbent” only works in very limited cases with 100% selectivity (discrimination). Almost always there is some metal deposition upon the component part that is not to be metallized. Especially in micro-applications this may be very critical and may lead to e.g. errors in electric circuits.
(b) Pre-catalyzed polymers are polymers of which the grain already contains compounds catalytic to the chemical metallization process, e.g. Pd particles or salts, which are used to build a metallizing seed layer. By using one component part made of a pre-catalyzed polymer and another one made of a not pre-catalyzed polymer, only the pre-catalyzed polymer component part will be metallized, while the other one will remain not-metallized. A drawback of this known method is the relative high price of the base material and the unfavourable influence on the characteristics of the relevant polymer.
(c) By using polymers containing substances that can be converted by photonic energy, e.g. by exposure to laser light, into catalytically active compounds for the chemical metallization process. In this way a pattern can be created on the surface. Only the parts exposed by the light will initiate chemical metallization. Also here a serious drawback is that the relevant additives have a negative effect on the polymer's characteristics.
(d) Selective metallizing may alternatively be performed by means of masks upon the component's surface. In most cases the components are metallized completely, after which the desired pattern is etched via a lithographic mask.

### SUMMARY OF THE INVENTION

The present invention is based on the use of different chemical solubility or resistance of different (e.g. polymeric or ceramic) materials. The method comprises the metallizing of a component that is constituted by a first part, made of a first material, and a second part, made of a second material. According to the inventive method a metallizing seed layer, which may be catalytic to the further metallization process, is applied at the surface of said component or a relevant part of that component's surface, after which the surface of the whole component or at least the relevant part of it, including said seed layer, is exposed to a “discriminating” solvent in which the surface material of said first part is soluble but the surface material of said second part is not. The first material may be a first polymer or other plastic, the second material a second polymer or plastic. Also other kinds of non-conductors, like e.g. ceramics, may be applied as first and/or second material.

After the surface has been exposed to a solvent in which the first part is and the second part is not soluble, the first part's surface, including its seed layer, will be solved in the solvent and eliminated. The metallizing seed layer thus will only stay at the surface of the second component part, which was made of a material, not soluble in (well resistant to) the used solvent. After a subsequent exposure of the (complete) component to a metallizing environment, only that component part, the second part, on which the metallizing seed layer was left after exposure of the “discriminating” solvent, will be metallized, due to the presence of the remaining seed layer at the second component part and the absence of it at the first part.

### FIGURES

FIGS. 1a-g illustrate schematically the metallizing process of a component with two parts made of different materials.

FIG. 1a shows a component, consisting a first component part 1, made of a first material e.g. polymer, and a second component part 2, made of a second material e.g. polymer.

FIG. 1b illustrates that the whole component is exposed to an activating or etching environment 3 (e.g. an etching bath) to get a hydrophilic and roughened surface 4 for good bonding properties.

FIG. 1c shows that the component surface 4 is —in a processing environment 5—“sensitized” for metallizing, e.g. by adsorption of Sn ions to the surface and subsequent activation, e.g. by reduction of Pd ions to metallic Pd by means of said Sn ions, resulting in a metallizing seed layer 6.

FIG. 1d shows that, subsequently, the surface of the component, including the seed lyer 6, is exposed to a solvent 7, in which the surface of said first component part 1 is soluble but the surface of the second component part 2 is not. The surface of component part 1, including the seed layer 6 upon it, will thus be solved in (or etched by) the solvent 7 after which the residue can be removed.

FIG. 1e shows that the metallizing seed layer 6 only stays at the surface of the second component part 2, represented by a partial seed layer 8.

FIG. 1f shows that, after exposure of the (whole) component to a metallizing environment 9, only component part 2, covered by the partial seed layer 8, will be metallized—represented by metal layer 10—due to the absence of the seed layer at the first component part 1 and the presence of it at part 2. The metallizing environment 9 may be based on of catalytic reduction of a metal coating (e.g. Cu or Ni) applied upon the seed layer 8 from a solution comprising both the relevant coating metal ions and a reduction chemical.

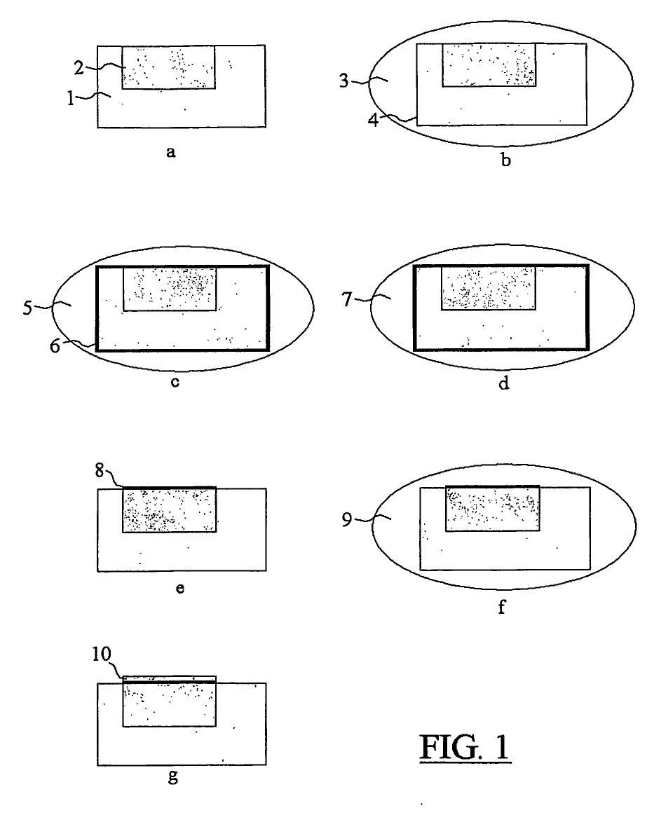

The result of the final metallizing process, represented by FIG. 1g, is a two-part component, of which only one part, viz. part 2, is covered by metal layer 10, while the other part, part 1, remains un-covered, due to the absence of the metallizing seed layer 6, which was solved by the “discriminating” solvent 7 (FIG. 1d).

There are lots of solvents known in which different plastics show different solubilities and which will thus be fit for the process of FIG. 1d, for example (source: http://www.kimble-kontes.com/pdfs/solvent_compatibility_{—}2.pdf):

| Abbreviation | Chemical Designation |
|---|---|
| ABS | Acryl-Butadienestyrene |
| | Acetal (Delrinⁿ⁵, Celcon²) |
| LDPE | Low Density Polyethylene |
| HDPE | High Density Polyethylene |
| NYL | Polyamide (Nylon^{·2}) |
| PCTFE | Polychlorotrifluoroethylene (Kel-Fⁿ⁵) |
| PC | Polycarbonate |
| PP | Polypropylene |
| PTFE | Polytetrafluoroethylene (Teflon^{·5}) |
| PVC | Polyvinyl Chloride |
| PVDF | Kynar (polyvinyldene fluoride) |
| E-CTFE | Ethylene Chlortrifluoroethylene |
| ETFE | Ethylene Tetrafluoroethylene (Tefzel^{·5}) |
| PFA | Perfluoroalkoxy (Teflon^{·5}) |
| San | Styrene |
| PMP | Polymethylpentene (TPX) |
| PMMA | Polymethylmetyacrylate (PMMP) |
| PS | Polystyrene |
| PEEK | Polyetheretherketone |
| TFE | Tetrafluoroethylene (Teflon^{2·}) |

| | PLASTIC RESIN MATERIAL | | | | | | | | |
|---|---|---|---|---|---|---|---|---|---|
| SOLVENT | ABS | Acetal | E-CTFE | ETFE | HDPE | LDPE | NYL | PC | PCTFE |
| Acetaldehyde | D | A | A | A | B | C | C | C | A |
| Acetic Anhydride | C | D | A | A | D | D | C | D | A |
| Acetone | D | D | A | B | C | C | B | D | A |
| Acid, Hydroflouric | C | D | A | A | A | A | D | D | A |
| Acid, Trifluoroacetic | D | C | C | C | C | D | D | D | A |
| Acid, Acetic Dilute 50% | A | C | B | B | A | A | D | B | A |
| Acid, Hydrochloric 37% | C | D | A | A | A | A | D | D | A |
| Acid, Nitric | B | D | A | A | B | C | D | B | A |
| Acid, Sulfuric | D | D | A | A | A | B | D | C | A |
| Actonitrile | D | D | A | A | A | A | A | D | |
| Alcohol, Ethyl | A | D | A | A | A | B | D | B | A |
| Alcohol, Isobutyl | A | A | A | A | A | A | D | B | A |
| Alcohol, Methyl | D | B | A | A | A | A | D | B | |
| Alcohol, n-Buty | A | A | A | A | A | A | D | C | A |
| Alcohol, Propyl | B | A | A | A | A | A | D | D | A |
| Ammonium Hydroxide | B | A | A | A | A | A | C | | A |
| Aniline | D | B | A | A | B | B | B | B | A |
| Aqua Regia | D | D | B | C | C | D | D | D | A |
| Benzaldehyde | B | A | B | B | A | B | B | C | A |
| Benzene | D | A | B | B | D | D | A | D | B |
| Carbon Tetrachloride | D | B | A | A | C | B | A | D | A |
| Caustic Soda (NaOH) | B | B | A | A | A | B | B | D | A |
| Chlorobenzene | D | D | B | B | C | D | B | D | A |
| Cloroform | D | B | B | B | C | C | D | D | B |
| Cyclohexane | A | A | B | B | C | C | A | D | A |
| Esters | D | D | A | A | B | B | A | D | B |
| Ether | D | A | B | B | C | D | A | C | B |
| Ether, Diethyl | D | D | B | B | D | A | C | D | C |
| Ether, Isopopyl | B | A | A | A | A | A | B | A | A |
| Ethtyl, Methyl | D | B | A | A | B | A | B | D | A |
| Hexane | D | B | A | A | B | D | A | C | A |
| Hydrazine | B | B | A | A | | | | D | B |
| Hydrogen Peroxide | B | B | A | A | A | D | B | A | A |
| Methylene Chloride | D | B | A | A | C | D | A | D | A |
| Petroleum Ether | B | A | A | A | A | B | A | A | |
| Phenol | D | C | A | A | D | D | D | D | A |
| Sodium Hydroxide | B | D | A | A | A | B | B | D | A |
| Tetrahydrofuran | D | A | A | A | B | C | A | D | A |
| Toluene | D | B | A | A | B | C | C | D | A |
| Trichloroethylene | D | B | B | B | C | D | B | D | A |
| Trimethylpentane,2,2,4 | D | C | B | B | C | C | A | D | |
| Water | A | A | A | A | A | A | A | A | A |
| Xylene | D | A | A | A | C | D | A | D | A |

PLASTIC RESIN MATERIAL

| SOLVENT | PEEK | PMP (TPX) | PP | PTFE | PVC | PMMP | PS | SAN | TFE |
|---|---|---|---|---|---|---|---|---|---|
| Acetaldehyde | A | C | C | A | D | D | D | D | A |
| Acetic Anhydride | A | B | B | A | D | D | D | D | A |
| Acetone | A | A | A | A | D | | D | D | A |
| Acid, Hydroflouric | A | A | B | A | B | D | D | C | A |
| Acid, Trifluoroacetic | A | D | D | A | D | D | D | D | A |
| Acid, Acetic Dilute 50% | A | A | A | A | B | D | B | D | A |
| Acid, Hydrochloric 37% | A | B | B | A | B | A | C | C | A |
| Acid, Nitric | A | A | B | A | B | C | C | C | A |
| Acid, Sulfuric | A | B | C | A | B | D | C | D | A |
| Actonitrile | A | C | C | A | D | | D | C | A |
| Alcohol, Ethyl | A | B | B | A | B | B | B | C | A |
| Alcohol, Isobutyl | A | A | A | A | B | B | B | | A |
| Alcohol, Methyl | A | A | A | A | B | D | C | C | A |
| Alcohol, n-Buty | A | B | A | A | A | B | B | B | A |
| Alcohol, Propyl | A | | A | A | A | | A | | A |
| Ammonium Hydroxide | A | B | B | A | B | C | B | D | A |
| Aniline | A | B | B | A | B | D | D | D | A |
| Aqua Regia | A | D | D | A | C | | D | | A |
| Benzaldehyde | | B | A | A | D | | D | D | A |
| Benzene | A | B | B | D | A | | D | D | A |
| Carbon Tetrachloride | A | D | B | A | B | D | D | D | A |
| Caustic Soda (NaOH) | A | A | A | A | D | D | A | D | A |
| Chlorobenzene | A | C | D | A | D | | D | | A |
| Cloroform | A | D | B | A | C | | D | D | A |
| Cyclohexane | A | D | C | A | D | D | D | | A |
| Esters | A | B | B | A | C | | D | | A |
| Ether | A | D | D | A | D | | D | D | A |
| Ether, Diethyl | A | D | D | A | D | C | D | D | A |
| Ether, Isopopyl | A | A | D | A | A | A | A | A | A |
| Ethtyl, Methyl | A | D | B | A | D | D | D | D | A |
| Hexane | A | C | B | A | C | C | D | A | A |
| Hydrazine | A | D | C | A | C | D | D | | A |
| Hydrogen Peroxide | A | A | A | A | A | A | B | | A |
| Methylene Chloride | D | C | C | A | D | C | D | D | A |
| Petroleum Ether | A | | A | A | B | D | B | | A |
| Phenol | A | D | D | A | C | D | C | D | A |
| Sodium Hydroxide | A | A | B | A | B | D | A | C | A |
| Tetrahydrofuran | D | C | B | A | D | D | D | D | A |
| Toluene | A | C | C | A | D | D | D | | A |
| Trichloroethylene | A | D | D | A | D | D | D | D | A |
| Trimethylpentane,2,2,4 | A | C | C | A | D | D | D | D | A |
| Water | A | A | A | A | A | A | A | A | A |
| Xylene | A | C | C | A | D | D | D | D | A |

A = NO EFFECT, EXCELLENT
B = MINOR EFFECT, GOOD
C = MODERATE EFFECT, FAIR
D = SEVERE EFFECT, NOT RECOMMENDED

As an example, experimented by the applicant in practice, a component may comprise the first part 1 made of PC and the second part 2 of ABS. Using, in the step as depicted in FIG. 1d, a 400 g/l sodium hydroxide (NaOH) solution as discriminating solvent 7, for which solvent ABS is well resistant (class B in the above table) and PC is not-resistant (class D in the table), resulted in a nearly 100% selective metallizing of the ABS component part 2 with a metallic (Cu) layer 10, covering the previously produced seed layer 8, while the PC component part 1 remained uncovered.

In general, pointing to the above solvents resistance table, a combination of different materials and a solvent has to be chosen for component parts 1 and 2 respectively, for which the material of part 1 has a low resistance (class D) for the relevant solvent, and part 2 a excellent or good resistance (class A or B). Besides, there are requirements to e.g. the moulding characteristics etc.

Further, it is noted that the present inventive method, using a “discriminating solvent”, solving and/or etching the surface of the component part that has a low resistance to the relevant solvent, may be used in combination with the known method, referred in the paragraph “Background of the invention” under section (a) “Selective surface conditioning”, using a “discriminating adsorbent” that has different (adsorption) properties for the different materials of which the parts 1 and 2 are made. Both, use of the known “discriminating adsorbent” (FIG. 1c) and the inventive “discriminating solvent” (FIG. 1d) may enforce each other, thus enhancing the final result.

Finally, for good order, the known method, using a “discriminating adsorbent” has to do with the forming of the metallizing seed layer 6. The aim of said known method is to produce a seed layer 6 only at the surface of e.g. the component part 2. As said before, the results of this known method are rather poor and only works satisfactory in a very limited number of combinations of materials: in practice also at the surface of component part 1 a seed layer 6 will be formed more or less. The inventive method, using a “discriminating” solvent” has to do with selective etching away the previously formed seed layer 6, using a solvent or etching medium to which only the material of part 1 is not resistant, thus etching away (only) the surface of part 1, together with its metallizing seed layer 6.

1. A method for selectively metallizing a component which component comprises a first part, constituted by a first material, and a second part, constituted by a second material, the method comprising the steps of:
(a) applying a metallizing seed layer on at least a part of the surface of said first part and of said second part;
(b) exposing a relevant surface of the component, including said metallizing seed layer, to a solvent in which the material of said first part is soluble and the material of said second part is not soluble, thereby providing a metallizing seed layer on said second part but not on said first part.

2. The method of claim 1, wherein the first material and/or the second material is a plastic or polymer.

3. The method of claim 1, wherein the first material and/or the second material is a ceramic material.

4. The method of claim 1, which further includes the step of exposing the surface of the component to a metallizing environment.

5. A system for metallizing a component that comprises a first part, constituted by a first material, and a second part, constituted by a second material, the system comprising:
means for producing a metallizing seed layer at the surface on at least a part of said first part and of said second part, and
means for exposing the relevant surface of the component, including said metallizing seed layer, to a solvent in which the material of said first part is soluble and the material of said second part is not.

6. A component comprising a first part, constituted by a first material, and a second part, constituted by a second material, which surface of said first part is soluble and the surface of said second part is not soluble in at least one specific solvent, and
wherein the second part but not the first part comprises a metallizing seed layer.

7. The component of claim 6, in which the first material and/or the second material is a plastic or polymer material.

8. The component of claim 6, in which the first material and/or the second material is a ceramic material.

9. The component of claim 6, wherein said seed layer of the second part is covered by a metallic layer.

10. The system of claim 5 which further includes:
means for providing a metallizing environment.

11. A component obtained by the method of claim 1.

12. A component obtained by the method of claim 4.
